(19) United States
(12) Patent Application Publication
(10) Pub. No.: US 2026/0192863 A1
(43) Pub. Date: Jul. 9, 2026

(54) Component Connection for a Body of a Motor Vehicle, and Method for Producing the Component Connection

(71) Applicant: Bayerische Motoren Werke Aktiengesellschaft, Muenchen (DE)

(72) Inventors: Gerhard BUTZ, Pfeffenhausen (DE); Jan DANNEBERG, Muenchen (DE); Alireza GHASSEMPOUR, Muenchen (DE); Christian GIROLSTEIN, Muenchen (DE); Angela HELZEL, Landshut (DE); Stefan KUGELMANN, Muenchen (DE); Juergen LESCHHORN, Geltendorf (DE)

(21) Appl. No.: 18/867,048

(22) PCT Filed: Jun. 27, 2023
(86) PCT No.: PCT/EP2023/067461

§ 371 Date: Nov. 19, 2024

(30) Foreign Application Priority Data
Jul. 12, 2022 (DE) 10 2022 117 396.8

(51) Int. Cl. B62D 27/02; B62D 29/04

(52) U.S. Cl. CPC B62D 27/02; B62D 29/048

(57) ABSTRACT

A component connection for a body of a motor vehicle includes at least two components which each have a flange adjoining a planar portion, which flanges are interconnected in the region of a flange connection. A level sealing and abutment face without height variations can be provided simply, due to the flange connection, by forming a recess which is lowered in relation to the planar portions adjoining the flanges and which is filled with a filler up to the height of the planar portions of the components that adjoin the flanges. The two planar portions and the filler form an at least substantially level sealing face.

### BACKGROUND AND SUMMARY

The invention relates to a component connection for a body of a motor vehicle. Furthermore, the invention relates to a method for producing such a component connection.

Such a component connection is already known, for example, from DE 10 2020 205 576 A1 , wherein a body for a passenger vehicle is composed of a large number of components, in this instance in the form of formed sheet metal parts. Particularly in the region of the floor structure of the body, for example, two sheet metal components which have a respective flange which adjoins a flange region of the sheet metal component are provided in this case and are connected to each other in the region of a flange connection.

In this instance, a discontinuity always occurs at such overlap locations or flange connections of respective body components, that is to say, usually a vertical jump occurs between the metal sheets. Particularly when, for example, such metal sheets are intended to be used as an abutment face or as a sealing flange, for example, in order to seal the passenger compartment of the body of an electrically driven motor car with respect to a battery housing of an energy store for the electrical drive of the passenger motor vehicle, such vertical jumps at the sealing gap between the sealing flange at the body side and the corresponding flange at the battery housing side are unfavorable. This vertical jump can, for example, result in a local detachment or non-abutment of a seal between the sealing flange on the carcass and the sealing flange on the battery housing, wherein undesirable capillary effects, via which, for example, water or similar moisture, can be introduced through the sealing arrangement can then occur.

An object of the present invention is therefore to provide a component connection and a method of the type mentioned, by means of which an improved connection of respective components, in particular body components, can be provided.

This object is achieved according to the invention by a component connection and by a method for producing such a component connection having the features of the independent claim(s). The dependent claims relate to advantageous embodiments of the invention.

The component connection according to the invention for a body of a motor vehicle comprises at least two components, in particular body components, which have a respective flange which adjoins a surface region of the associated component and which are connected to each other in an overlapping manner in the region of a flange connection.

In order to provide a component connection in this case, wherein, for example, a planar sealing and abutment face can be readily provided without any vertical jump, there is provision according to the invention for there to be formed by the flange connection a recess which is lowered with respect to the surface regions, which adjoin the flanges, of the respective components, and which is filled with a filler material, in particular a plastics material, up to the height of the regions, adjoining the flanges, of the components, wherein the two surface regions and the filler material form an at least substantially planar sealing side.

Consequently, the flange connection is configured according to the invention so that it provides a recess, which is filled by a filler material so that the filler material forms with the respective surface regions which adjoin the flanges a preferably at least substantially planar face or sealing side so that, at the corresponding side of the components, a preferably at least substantially continuous face of the component connection is formed, which face can be used, for example, as a sealing flange for securing a battery housing of an energy store for supplying an electric drive of the motor car with electrical energy.

Consequently, according to the invention at least one carcass flange, but particularly both carcass flanges, of the two components in the region of the overlap location or the flange connection, is configured so as to be accordingly lowered with respect to the sealing plane which is located outside the flange region and which is formed by the surface regions, which adjoin the flanges, of the components. The recess which is thereby produced is accordingly filled with the corresponding filler material, for example, a material applied in a pasty state, such as an adhesive or a PVC plastics material, during the production process of the component connection or the body or in the subsequent painting process, and subsequently smoothed by a manual or automated spreading. By the filler material drying or curing, consequently, a smoothed surface, the sealing face, which can be used, for example, as a flange for the planar sealing abutment without any vertical jump of the components, remains.

The at least two components are, for example and in particular, in the form of sheet metal components which are connected to each other, for example, by joining, in particular welding, and further particularly by spot-welding. However, any other connection technologies between the two components may be used. Furthermore, at least one of the two components can also be in the form of an extrusion profile, cast components or the like. Other materials of the components are also possible.

Furthermore, it has been found to be advantageous if the two flanges of the respective components are formed in a lowered manner with respect to the adjoining surface region of the respective components. A particularly advantageously lowered overlap location of the two components which can be readily filled by the filler material is thereby produced.

Alternatively, however, it is also simply necessary for only one of the two flanges of the corresponding component to be configured in a lowered manner with respect to the adjoining surface region, wherein the other of the two flanges extends at one height with the adjoining surface region or forms one plane with this region. A particularly favorable recess which can be filled with filler material can also thereby be provided, and consequently a planar sealing side can be provided.

In another embodiment of the invention, it has been found to be advantageous if, as a result of the components and the recess filled by the filler material, a planar sealing flange is formed. This sealing flange can be sealed in a particularly simple manner, for example, against a corresponding flange of a battery housing of an energy store for electrically driving the motor car.

Furthermore, it has been found to be advantageous if the flange connection extends transversely relative to the sealing flange which is formed by the two components and the recess which is filled by the filler material. Consequently, on the one hand, a corresponding design freedom when configuring and connecting respective components of the body of the motor car can be provided and, on the other hand, a particularly favorable abutment face—the sealing flange—against which, for example, a flange of a battery housing can be sealed in the manner described above.

The advantages described in connection with the component connection also apply to the method according to the invention.

Additional features of the invention will be appreciated from the claims, Figures and description of the Figures. The features and feature combinations mentioned above in the description and the features and feature combinations mentioned below in the description of the figures and/or shown in the figures alone can be used not only in the combination set out but also in other combinations or alone.

The invention is now explained in greater detail with reference to a preferred exemplary embodiment and the drawings.

### BRIEF DESCRIPTION OF THE DRAWINGS

FIG. 1 shows a cutout of a view from below of a body of a motor vehicle in the region of a floor structure, wherein a large number of components are assembled to form the body, and in the region between respective lateral longitudinal carriers and front and rear transverse carriers there is formed a window-like opening with a sealing flange which is circumferential on the body and on which a battery housing of an energy store for electrically driving the motor car can be secured by means of a correspondingly circumferential corresponding flange, and three detailed views of the floor structure in the region of the circumferential sealing flange, in which two components which have a respective flange which adjoins a surface region of the corresponding component and which are connected to each other in the region of a flange connection, by which a lowered recess which is filled with a filler material up to the height of the surface regions which adjoin the flanges is formed, are connected to each other in order thereby to form the planar sealing flange for securing the battery housing.

FIG. 2a shows a cutout of an enlarged sectional view of a component connection of the respective components which are connected to each other by means of a corresponding flange connection so as to form a lowered recess, in which a filler material is applied in a first method step.

FIG. 2b shows a cutout of a sectioned view of the component connection according to FIG. 2a, wherein in this case the filler material has been spread accordingly within the recess so that the filler material forms with the surface regions, which adjoin the flanges of the flange connection, of the respective sheet metal components an at least substantially planar sealing face of a sealing flange which is connected to the sealing flange on the battery housing with a seal being interposed.

FIG. 3 shows a sectioned view of a component connection according to an alternative embodiment with respect to FIG. 2a, with the filler material already being applied but not yet spread.

### DETAILED DESCRIPTION OF THE DRAWINGS

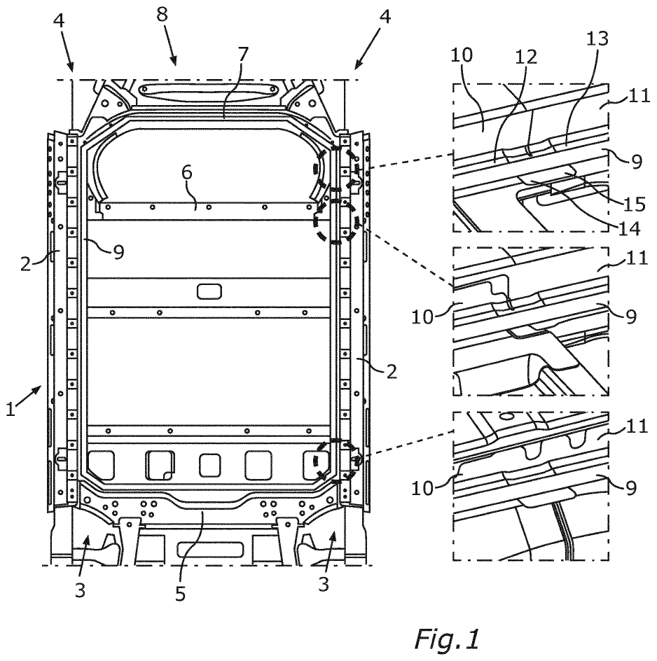

FIG. 1 is a cutout of a plan view of a floor structure 1 for a body of a passenger vehicle, of which substantially lateral longitudinal carriers 2 which extend between front wheel housings 3 and rear wheel housings 4 can be seen. Furthermore, the floor structure 1 comprises a front transverse carrier 5 and a first rear transverse carrier 6 and a second rear transverse carrier 7, at which the floor structure merges into a rear part of the vehicle 8. In this case, the lateral longitudinal carriers 2, the front transverse carrier 5 and the rear transverse carrier 7 form an opening, around which a schematically depicted sealing flange 9 is formed at the external circumference and on which a battery housing of an energy store for electrically driving the motor car can be secured by means of a corresponding flange which extends around the battery housing at the lower side of the floor structure 1 in a manner described in even greater detail below.

In the present exemplary embodiment, the battery housing, in particular the upper portion thereof, further forms the vehicle floor of the floor structure 1 or of the passenger compartment which is arranged above the floor structure 1. Inter alia, for this reason, it is absolutely necessary for the circumferential sealing flange 9 of the floor structure and the sealing flange, which will be explained in even greater detail below, of the battery housing to form a fluid-tight arrangement so as to form a seal in order to avoid penetration of water or similar moisture from the exterior into the interior of the motor vehicle.

On the right in FIG. 1, three cutout detailed views of the left view from below are shown in a different viewing direction. In this case, it is possible to see a respective component connection of two components 10, 11 which are in the form of sheet metal components in the present exemplary embodiment and which have a respective flange 14, 15, which adjoins a flange region 12, 13, and which are connected to each other in the region of a flange connection 16.

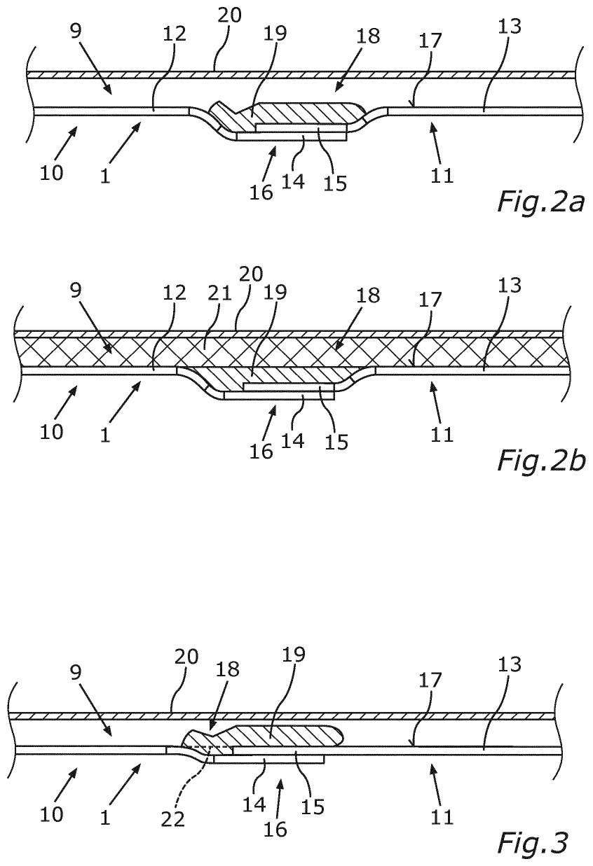

This respective component connection is illustrated in FIG. 2a as a cutout of a sectional view, which is drawn to an enlarged scale with respect to FIG. 1. In this case, it can be seen that the two flanges 14, 15 or the flange connection 16 is/are lowered with respect to the surface regions 12, 13, which are located outside the flange connection 16, of the respective sheet metal components 10, 11 which at least substantially form a plane at the upper side or sealing side 17 thereof. In other words, a recess 18 which is lowered with respect to the sealing side 17 of the surface regions 12, 13—as illustrated in FIG. 2a—is filled at the overlap location which forms the flange region 16 with a filler material 19, which is in particular a plastics material, for example, an adhesive or a PVC sealing substance. In this case, this filler material 19 is in particular a material which can be applied in a pasty state and which according to FIG. 2a is initially applied, for example, in a corresponding bead in the region of the recess 18.

Before the filler material 19 is applied, the two sheet metal components 10, 11 have been connected to each other in the region of the flanges 14, 15 thereof, for example, by joining, in particular by welding, and particularly by spot-welding. After the joining, the present sheet metal components 10, 11 have been covered in the context of a painting operation, for example, a cathodic dip painting and/or another painting operation. Consequently, the filler material 19 is preferably applied to the already painted sheet metal components 10, 11. However, it is where applicable also possible to apply the filler material 19 to the metal sheets 10, 11 which are as yet untreated and to provide them subsequently with a covering, for example, a painting or the like.

According to FIG. 2b, which shows a sectioned view similar to FIG. 2a, in a subsequent method step the material which is applied in a pasty state, that is to say, the filler material 19, is smoothed by manual or automatic spreading so that the two surface regions 12, 13 of the sheet metal components 10, 11 and the filler material 19 form a smooth, at least substantially planar face on the sealing side 17 of the component connection. The curing of the pasty material can be carried out, for example, in an oven process or at ambient temperature. Where applicable, the curing can also be carried out in the context of the cathodic dip painting.

According to FIG. 2b, the smoothed flange region 16 then remains without any vertical jump, that is to say, the uniformly planar sealing side 17 of the component connection which again partially forms the respective sealing flange 9 which can be seen in FIG. 1.

As can further be seen in FIGS. 2a and 2b, a sealing flange 20 of the battery housing of the energy store for electrically driving the motor car extends with spacing from this sealing flange 9 with the sealing side 17 via a seal 21 which can be seen in FIG. 2b. Since a uniform gap without any vertical jump in the region of the flange connection 16 is provided between the sealing flange 9 or the sealing side 17 of the component connection, on the one hand, and the flange 20 of the battery housing, there is produced at both sides and particularly at the sealing side 17 of the component connection 10, a planar sealing abutment for the seal 21 so that it cannot become detached locally or a local non-abutment of the seal 21 is effectively avoided.

Taken together with FIGS. 1 and 2a and 2b, it becomes increasingly evident that in this case the flange connection 16 extends substantially transversely and particularly perpendicularly to the sealing flange 9 which encloses the seal 21 with the flange 20.

FIG. 3 shows, similarly to FIG. 2a, a sectioned view through the component connection of the two sheet metal components 10, 11 according to another embodiment. In this embodiment, only the flange 14 of the left sheet metal component 10 is formed accordingly in a lowered manner by forming or the like, whereas the other flange 15 of the other sheet metal component 11 is formed in a planar manner with the associated surface region 13 of the corresponding sheet metal component 11. While, consequently, in the embodiment according to FIG. 2a, both flanges 14, 15 are lowered downward or formed with respect to the associated surface regions 12, 13 in order to form the recess 18, according to the embodiment in FIG. 3 only one flange 14 is accordingly formed correspondingly and formed in a lowered manner. In this case, the flange 14 is lowered downward substantially by a wall thickness of the flange 15 or the surface region 13 of the sheet metal component 11 so that there is produced, after the flange connection 16 is formed, a component connection in which the two surface regions 12, 13 of the two sheet metal components 10, 11 and the flange 15 of the sheet metal component 11 are located at least substantially in one plane at the sealing side 17 thereof or form a plane.

In this case, the recess 18 which is filled in this case similarly to FIG. 2a by the filler material 19 is again produced between the free end of the flange 15 and by the formation of the flange 14. Following the filling, which is shown here, a manual or automated spreading is carried out again so that the filler material 19 forms at the sealing side 17 thereof a planar face 22 which forms a uniform plane on the sealing side 17 with the mentioned surface regions 12, 13 and the flange 15.

Overall, consequently, a planar sealing flange 9 can also be provided in order to obtain the advantages already described.

### LIST OF REFERENCE NUMERALS

1 Floor structure
2 Longitudinal carrier
3 Front wheel housing
4 Rear wheel housing
5 Front transverse carrier
6 Rear transverse carrier
7 Second rear transverse carrier
8 Rear part of vehicle
9 Sealing flange
10 Sheet metal component
11 Sheet metal component
12 Surface region
13 Surface region
14 Flange
15 Flange
16 Flange connection
17 Sealing side
18 Recess
19 Filler material
20 Sealing flange
21 Seal
22 Planar face

1.-19. (canceled)

10. A component connection for a body of a motor vehicle, comprising:
at least two components, each having a flange which adjoins a surface region, and which are connected to each other in a region of a flange connection, wherein
the flange connection forms a recess which is lower with respect to the surface regions of the two components which adjoin the flanges of the two components,
a filler material fills the recess up to a height of the surface regions adjoining the flanges of the two components, and
the surface regions of the two components and the filler material form an at least substantially planar sealing side.

11. The component connection according to claim 10, wherein
the two flanges are formed so as to be lower with respect to the adjoining surface regions of the two components.

12. The component connection according to claim 10, wherein
one of the two flanges is configured so as to be lower with respect to its adjoining surface region, and
the other of the two flanges is located at a same height as its adjoining surface region.

13. The component connection according to claim 10, wherein a plastics material is the filler material.

14. The component connection according to claim 13, wherein the plastics material is a PVC plastics material.

15. The component connection according to claim 10, wherein
the two components and the recess filled by the filler material provide a planar sealing flange.

16. The component connection according to claim 10, wherein
the flange connection extends transversely to the sealing flange.

17. The component connection according to claim 10, wherein
the two components are sheet metal components.

18. A method for producing a component connection for a body of a motor vehicle, comprising:
providing at least two components, each having a respective flange which adjoins a respective surface region, for connection to each other in a region of a flange connection;
forming a recess with the flange connection, which recess is lower with respect to the respective surface regions adjoining the respective flanges; and
filling the recess with a filler material up to a height of the respective surface regions adjoining the respective flanges of the two components, wherein an at least substantially planar sealing side is formed by the respective surface regions and the filler material.

19. The method according to claim 18, wherein the recess is filled with the filler material after at least one paint has been applied.
